(19) United States
(12) Patent Application Publication
(10) Pub. No.: US 2018/0137695 A1
(43) Pub. Date: May 17, 2018

(54) Radio Frequency Emissions Sensing System and Method for the Characterization of System Operation

(71) Applicant: CTS Corporation, Lisle, IL (US)

(72) Inventors: Alexander G. Sappok, Cambridge, MA (US); Paul A. Ragaller, Dorchester, MA (US); Leslie Bromberg, Sharon, MA (US); Andrew D. Herman, Granger, IN (US)

(73) Assignee: CTS Corporation, Lisle, IL (US)

(21) Appl. No.: 15/687,755

(22) Filed: Aug. 28, 2017

Related U.S. Application Data
(63) Continuation-in-part of application No. 15/481,670, filed on Apr. 7, 2017.
Application No. 15/481,670 is a continuation-in-part of application No. 15/461,128, filed on Mar. 16, 2017.
Application No. 15/461,128 is a continuation-in-part of application No. 14/733,525, filed on Jun. 8, 2015.
Application No. 14/733,525 is a continuation-in-part of application No. 14/733,486, filed on Jun. 8, 2015.
(60) Provisional application No. 62/380,667, filed on Aug. 29, 2016.

(51) Int. Cl. G07C 5/08; G07C 5/02; G07C 5/00; H04L 29/08

(52) U.S. Cl. CPC G07C 5/0808; G07C 5/02; G07C 5/085; B60W 2510/0676; H04L 67/12; B60W 2510/068; G07C 5/008

(57) ABSTRACT

An RF emissions sensing system including RF sensors for transmitting/receiving RF signals to and from engine system emission control components, a control unit for collecting/processing information from the RF signals and controlling system outputs. The RF emissions sensing system includes a means and method for the characterization of the operating state and/or performance of the engine system including the use of time-based or historical RF information and system outputs, the application/monitoring of pertubations to the engine system, the comparison of system outputs to baseline/reference system outputs, the periodic activation of the engine system after shut-down, the monitoring of changes in the electric or temperature profiles of the engine system emission control components, and communication with external sources to improve the accuracy of the system outputs.

### CROSS-REFERENCE TO RELATED APPLICATIONS

This patent application claims priority and benefit of the filing date of and is a continuation-in-part of U.S. patent application Ser. No. 15/481,670 filed on Apr. 7, 2017, U.S. patent application Ser. No. 15/461,128 filed on Mar. 16, 2017, U.S. patent application Ser. No. 14/733,525 filed on Jun. 8, 2015, and U.S. patent application Ser. No. 14/733,486 filed on Jun. 8, 2015, the disclosure and contents of which are expressly incorporated herein in their entireties by reference.

This patent application also claims priority and benefit of the filing date of U.S. Provisional Patent Application Ser. No. 62/380,667 filed on Aug. 29, 2016, the disclosure and contents of which is expressly incorporated herein in its entirety by reference.

### FIELD OF THE INVENTION

This invention relates to a radio frequency emissions sensing system and, more specifically, to a radio frequency emissions sensing system and method of using the radio frequency emissions sensing system for the characterization of the operating state and/or performance of an engine system.

### BACKGROUND OF THE INVENTION

There are many conventional exhaust emissions sensing technologies-pressure, temperature, and chemical gas sensors which can only measure elements contained in the exhaust gas stream. These measurements coupled with sophisticated and complex algorithms often generate limited operational windows and/or potential for a miscalculation of the area of interest state.

RF exhaust/emissions sensing technology such as for example the RF exhaust sensing technology and systems covered in U.S. Pat. Nos. 8,384,396 and 8,384,397 to Bromberg et al. provide a direct real-time measurement of the engine exhaust aftertreatment system of interest, providing higher quality information under a broader range of operating conditions than other technologies.

The present invention is directed to a new radio frequency emissions sensing system and method of using the radio frequency emissions sensing system to characterize the operating state and/or performance of an engine system.

### SUMMARY OF THE INVENTION

The present invention is generally directed to a radio frequency emissions sensing system for an engine system comprising one or more radio frequency sensors adapted to transmit and receive radio frequency signals to and from one or more emission control components, a system control unit adapted for collecting and processing radio frequency information from the radio frequency signals transmitted to and received from the one or more radio frequency sensors and controlling one or more system outputs, and means for the characterization of the operating state and/or performance of the engine system.

In one embodiment, the means for the characterization of the operating state and/or performance of the engine system comprises means adapted to use time-based or historical radio frequency information and/or the one or more sensing system outputs.

In one embodiment, the system further comprises means for storing historical radio frequency information and comparing the historical radio frequency information against the radio frequency information for the characterization of changes in the operating state and/or performance of the engine system.

In one embodiment, the means for the characterization of the operating state and/or performance of the radio frequency emissions system comprises means adapted to apply pertubations to the engine system.

In one embodiment, the means for the characterization of the operating state and/or performance of the engine system comprises means for monitoring pertubations to the engine system that occur during the operation of the engine system.

In one embodiment, the means for the characterization of the operating state and/or performance of the engine system comprises means for comparing the one or more system outputs to a baseline or historical output at a predefined condition, where the predefined condition is selected from: temperature, operating mode, start-up or shut-down conditions.

In one embodiment, the means for the characterization of the operating state and/or performance of the engine system comprises means for the periodic activation of the radio frequency emissions system after plant shut-down to conduct measurements to characterize the state or change in state of the engine system.

In one embodiment, the means for the characterization of the operating state and/or performance of the engine system comprises means for monitoring changes in the bulk electric of the one or more emissions control components.

In one embodiment, the means for the characterization of the operating state and/or performance of the engine system comprises means for monitoring the temperature profile of the one or more emissions control components.

In one embodiment, the means for the characterization of the operation state and/or performance of the engine system comprises means for monitoring the bulk temperature of the one or more emissions control components.

In one embodiment, the means for the characterization of the operating state and/or performance of the engine system comprises means for communication with external sources to improve the accuracy of the sensing system outputs.

The present invention is also directed to a method of operating a radio frequency emissions sensing system comprising the steps of providing one or more radio frequency sensors for transmitting and receiving radio frequency signals to and from one or more emission control components, providing a system control unit for collecting and processing radio frequency information from the radio frequency signals transmitted to and received from the one or more radio frequency sensors and controlling one or more sensing system outputs, and characterizing the operating state and/or performance of the engine system.

In one embodiment, the step of characterizing the operating state and/or performance of the engine system comprises the step of comparing time-based or historical radio frequency information and/or the one or more system outputs.

In one embodiment, the method further comprises the step of storing historical radio frequency information and comparing the historical radio frequency information against the radio frequency information for the characterization of changes in the operating state and/or performance of the engine system.

In one embodiment, the step of characterizing the operating state and/or performance of the engine system comprises means includes the step of applying pertubations to the engine system.

In one embodiment, the step of characterizing the operating state and/or performance of the engine system comprises the step of monitoring pertubations to the engine system that occur during the operation of the engine system.

In one embodiment, the step of characterizing the operating state and/or performance of the engine system comprises the step of comparing the one or more sensing system outputs to a baseline or reference sensing system output at a specific point in time corresponding to specific temperature conditions.

In one embodiment, the step of characterizing the operating state and/or performance of the engine system comprises the step of periodically activating the engine system after plant shut-down to conduct measurements to characterize the state or change in state of the engine system.

In on embodiment, the step of characterizing the operating state and/or performance of the engine system comprises the step of monitoring changes in the bulk electric of the one or more emissions control components.

In one embodiment, the step of characterizing the operating state and/or performance of the engine system comprises the step of monitoring the temperature profile of the one or more emissions control components.

In one embodiment, the step of characterizing the operating state and/or performance of the engine system comprises the step of monitoring the bulk temperature of the one or more emissions control components.

In one embodiment, the step of characterizing the operating state and/or performance of the engine system comprises the step of communicating with external sources to improve the accuracy of the sensing system outputs.

Other advantages and features of the present invention will be more readily apparent from the following detailed description of the preferred embodiments of the invention, the accompanying drawings, and the appended claims.

### BRIEF DESCRIPTION OF THE DRAWINGS

These and other features of the invention can best be understood by the description of the accompanying FIGS. as follows:

FIG. 1 is a simplified schematic of an engine system incorporating a radio frequency emissions sensing, measurement and control system in accordance with the present invention;

FIG. 2A is a graph depicting changes in the radio frequency amplitude of the radio frequency output of the radio frequency emissions sensing, measurement, and control system of FIG. 1;

FIG. 2B is a graph depicting changes in the radio frequency phase of the radio frequency output of the radio frequency emissions sensing, measurement, and control system of FIG. 1; and

FIG. 3 is a graph depicting the change in one of the radio frequency parameters of the radio frequency outputs of the radio frequency emissions sensing, measurement, and control system of FIG. 1 as a function of time.

### DETAILED DESCRIPTION OF THE EMBODIMENT

The invention relates to a radio frequency (RF) sensor (antenna and RF electronics), engine and engine controller/aftertreatment controller, aftertreatment emissions sensing, measurement and control system 100 for an engine system consisting of an engine 102 and an engine exhaust aftertreatment system including various catalysts, filters, and ancillary sensors, dosing elements, and conduit. The engine system, as described herein, thus refers to the combined engine and emissions aftertreatment system.

Although the use of the invention of this patent application is directed to the RF sensing of vehicle engine exhaust/emissions systems, it is understood that the principles and features of this invention are applicable to any plant or process system including, but not limited to, the following: passenger cars, trucks, buses, construction equipment, agricultural equipment, power generators, ships, locomotives, and the like. Additional possible applications include chemical or power plants, in which a by-product of a controlled conversion process generates species of chemical compounds that must be regulated via additional control content such as electronic controls, catalysts, filters, supported by sensing elements such as temperature, pressure, flow, or chemical species, equipment that can introduce additional chemical agents that aid in the conversion of regulated chemical compounds into chemical compounds with inert or desired properties.

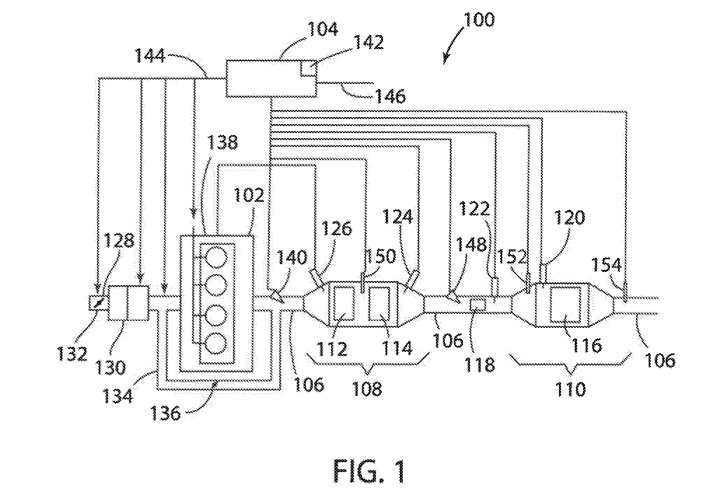

FIG. 1 depicts one exemplary embodiment of a radio frequency emissions/exhaust sensing, measurement, and control system (RF sensing system) 100 applied to a plant, such as an engine 102 including a control unit 104 such as for example an engine control unit, an aftertreatment control unit, or any type of control unit suitable for collecting information from one or more inputs (such as sensors), processing the input information, and controlling one or more outputs. The outputs may consist of sending out a signal or communicating with external devices, or commanding and controlling specific actions.

Engine 102 includes at least one outlet, such as an exhaust conduit 106 that is connected to one or more emissions control components including for example engine emission control components 108 and 110. The engine emissions control components may be particulate filters, catalysts, scrubbers, or other such devices. In one example engine emission control component 108 is a particulate filter system containing a catalyst 112, such as an oxidation catalyst, and a filter 114, such as a ceramic particulate filter and the engine emissions control component 110 is a catalyst system containing one or more catalysts 116, such as an SCR catalyst, TWC catalyst, ammonia slip catalyst, storage catalyst, oxidation catalyst, or any other type of catalyst. In the embodiment shown, the engine exhaust conduit 106 includes an additional filter or catalyst 118 located between and spaced from the emission control components 108 and 110. The particulate filter 114 may be a gasoline or diesel particulate filter, or any type of particulate filter.

Radio frequency sensors 120, 122, 124, and 126 are located in conduit 106 and engine exhaust aftertreatment emission control components 108 and 110. The radio frequency sensors may be used to transmit or receive radio frequency signals through all or a portion of conduit 106 and engine emissions control components 108 and 110 which can define respective radio frequency resonant cavities. The radio frequency sensors 120, 122, 124, and 126 may be coupled to one or more radio frequency control units. In one example, radio frequency control unit and the plant or process control unit 104 may be one in the same. In another embodiment, the radio frequency control unit may be separate from the engine control unit.

The plant or engine system 102 further comprises an intake system 128 which, in the embodiment shown, include a throttle 132, turbomachinery such as for example, a turbocharger or super charger 130, an exhaust gas recirculation system 134, an exhaust gas recirculation actuator 136, and a fuel supply system 138 comprising, for example, injectors, fuel supply and return conduit, pumps, and the like. Although not shown in FIG. 1, it is understood that the plant or engine system 102 could additionally comprise filters, heat exchangers, cooling systems, lubrication systems, and the like.

A pair of dosing or injection systems 140 and 148 are mounted and coupled to the engine exhaust conduit 106. In one example, component 140 may be a hydrocarbon doser, such as a fuel injector. In another embodiment, component 148 may be a urea doser. Although not shown in FIG. 1, it is understood that the dosing systems may further consist of fluid supply systems, hoses, lines, tanks, pumps, and the like.

Additional sensors 150, 152, and 154 can be present in the engine system in any number of positions, quantity, and form including for example temperature sensors, pressure sensors, gas composition sensors (NOx, O2, NH3, particle/soot sensors, and others).

Control unit 104 monitors and controls the sensors and processes via one or more communication paths or networks 144 comprising for example wiring harnesses or connections defining, for example, a controller area network (CAN) or any other suitable network or connection system. The signals monitored by control unit 104 on network 144 may be analog or digital. The network 144 may be physical, such as via a wired connection, or virtual such as via a wireless connection. Control unit 104 further includes internal components and processes 142 such as, for example, computer readable storage medium containing instructions, lookup tables, algorithms, and the like, used for processing one or more inputs and controlling one or more outputs. Control unit 104 includes additional power or external communication connections 146. One control unit or multiple control units may be present in the RF sensing system 100.

In one embodiment, at least one radio frequency transmitting/receiving probe may be connected to a radio frequency electronic control unit. In another embodiment, the radio frequency electronic control unit may be integrated with the radio frequency probe. In either embodiment, the combination of at least one radio frequency transmitting probe and electronic control unit may be considered a radio frequency sensor. The radio frequency sensor includes means for generating and transmitting radio frequency signals, which may include synthesizers, oscillators, or amplifiers, as well as means for detecting a radio frequency signal, such as diode detectors or logarithmic detectors in another example. The radio frequency sensor may also contain an internal processor or microcontroller for controlling the sensor operation and processing the measurement data.

The frequency range of operation may be chosen to be any suitable frequency range. In one example, the frequency range may be from 100 MHz to 3,000 MHz. The radio frequency signal may be broad band or narrow band. The signal may or may not include one or more resonant modes of an electrically-coupled cavity whose contents are of interest. In an example where one or more resonant modes are established in the electrically-coupled cavity, such as engine emissions control components 108 or 110 or conduit 106, observed changes in the signal near or at resonance provide a measure of the change in state of the electrically-coupled cavity, as well as the spatial location or general region where the change in the electrically-coupled cavity has occurred. The frequency range of the RF sensor operation may be fixed or variable. In another example, the monitored signal need not be at resonance or may not include one or more resonant modes.

In one example, the operating frequency range may be varied based on the measured RF signal, supplemental sensor information provided to the RF sensor control unit, or the control unit who is managing the RF sensor function. The transmitted power of the RF sensor may also be varied based on the measured RF signal, supplemental sensor information provided to the RF sensor control unit, or the control unit that is managing the RF sensor function.

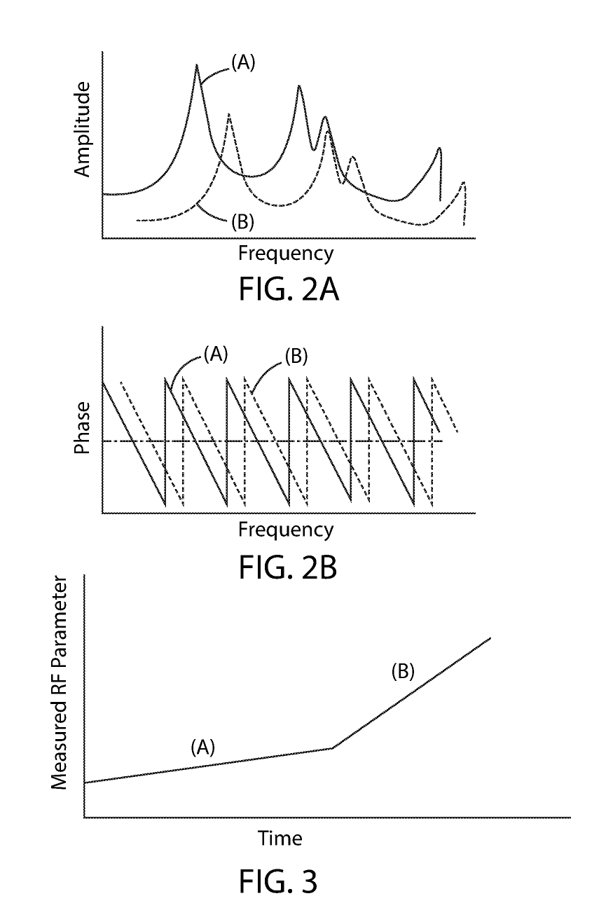

FIGS. 2A and 2B provide examples of the monitored radio frequency signal which may include the signal magnitude in FIG. 2A or phase in FIG. 2B or both magnitude and phase, in another example. Changes in the dielectric properties of the engine emission control components 108 or 110 or conduit 106, may be detected by changes in the radio frequency signal as shown in FIGS. 2A and 2B. FIG. 2A shows a reduction in the amplitude of the radio frequency signal over a given frequency range. Increase in the dielectric loss of the cavity or conduit may result in a reduction in signal amplitude of curve (B) relative to curve (A), as shown in FIG. 2A, or a shift in the frequency of the resonance curves, also shown in FIG. 2A. In another example, changes in the cavity or conduit dielectric properties may result in a shift in the phase of the radio frequency signal, which is depicted in FIG. 2B which shows the phase shift between curves (A) and (B).

The changes in the radio frequency amplitude and/or phase may be directly monitored and detected. Alternatively, a parameter derived from the amplitude, frequency, and/or phase measurements may be used to characterize the state of the cavities 108 or 110 or conduit 106. The derived parameter may include the maximum or minimum value at a given frequency or over a range of frequencies, or include the integrated area under all or a portion of the curve, the average of the values in a subset of the curve, the sum of the values, or a shift in frequency and/or phase, the quality factor of the signal, the frequency of a phase crossing, or some other statistic or parameter calculated from the amplitude, frequency, or phase information.

In another example, the rate of change of the signal or derivative thereof may also be computed. Any parameter derived from the magnitude, frequency, and/or phase measurements may generically be defined as an RF parameter. The parameter may be computed over the entire frequency measurement range, for a subset of frequencies, or only at a specific frequency. The measurements may or may not include frequencies sufficient to generate one or more resonant modes. The frequencies may be below or above the cutoff frequency of the system.

FIG. 3 provides one example showing the change in the RF parameter as a function of time. The RF parameter may relate to any number of parameters used to characterize the state of the engine 102 or engine emission control components 108 or 110 or conduit 106. Example of engine system characteristics include soot or ash emissions or accumulation levels on particulate filters, the adsorption or storage of NOx, NH3, O2, HC, or any number of gas species on catalysts, water or water vapor, the thermal aging or poisoning of catalysts, such as by sulfur, phosphorous, lead, or any number of constituents, or the temperature or other characteristic of the engine system. Additional characteristics may include cracking, melting, or other faults or failures of the engine emission control components, missing components, or other associated fault or failure conditions or malfunctions.

The characterization of the engine system operating state and/or performance utilizing the radio frequency sensor system sensors may be accomplished through one or more of the means and methods of the present invention as described in more detail below.

### Time/Historical RF Information

A first means and method in accordance with the present invention for characterizing the operating state and/or performance of the engine system shown in FIG. 1 comprises the use of time-based or historical RF information and/or additional system or model outputs, i.e. storing some portion of the operating history to be used to: (i) improve the accuracy of the RF measurements, (ii) compute an error signal as the difference between the expected and measured value, (iii) comparison of the current or historical information with threshold levels, (iv) filtering or integration of the measured or historical data to characterize the engine system.

In accordance with this method, the computer readable storage medium in the control unit 104 may be used to continuously or periodically store information either measured directly or computed from one or more sensor inputs to the system 100, where the sensor inputs include one or more radio frequency sensors and may include additional measurements from non-RF sensors, such as temperature sensors, pressure sensors, flow sensors, gas sensors, particle or soot sensors, or other sensors that may typically be used on engine or emissions aftertreatment systems. Information from the vehicle, such as engine speed/load, vehicle speed, engine torque, accelerometers, can also be saved.

The historical information may be stored for a finite time period or indefinitely. New data may be saved often, while older data may be selectively deleted, keeping some information but deleting other. A filter can be used to save selective information of older data. The older the data, the less filtering is done and additional information deleted. It may be desirable to keep a minimum information from old data that could be sufficient to build a time history of the performance of the unit.

Deviation of the current RF measurements, or measurements from non-RF sensors, from the historical measurements or a historical average value, by a specified amount, may indicate a change in the state of the engine system. The change may be abrupt, such as the change between the slopes of curves (A) and (B) shown in FIG. 3 (where the inflection point identifies the time in which a change occurred) or the change may be gradual, such as a gradual increase or decrease in the RF parameter or non-RF sensor value over time. Both curves (A) and (B) in FIG. 3 further show a gradual change in the RF parameter over time, in addition to an inflection point at the intersection of the curves. In this manner, changes to the engine system such as fault conditions, malfunctions, aging of the components or other changes may be monitored. Abrupt changes characterized by a step change or inflection point in the historical data or change in the general trend or behavior of the data relative to a threshold value or normal pattern of operation may indicate an instantaneous fault condition, malfunction, or change in system state. On the other hand, a gradual change or shift in the historical measurements may indicate a phenomena occurring over larger time scales, such as the aging of the engine system, gradual decrease in performance, or other related change (such as catalyst poisoning or aging in another example).

The measured historical data may be compared against threshold values (fixed values or set points) or dynamic models or calculations of the expected value which may or may not be updated based on the historical information.

In another example, the historical information may be used to improve the accuracy of the RF sensing system measurements, rather than detecting a change in engine system operation or fault condition. In one example, knowledge of a past RF measurement value, or the trend in the previous RF measurements, whether constant, increasing, or decreasing can be used to refine the current RF sensing system measurement. Examples include using the historical information to select a calibration function from a plurality of calibration functions, where each calibration function may be optimized for a particular measurement range. The selection of the best calibration function (most accurate, fastest, etc.) may rely on historical information from the radio frequency sensor, or from other non-RF sensors, such as temperature sensors, or any other sensor.

In another example, knowledge of the historical RF information may be used to improve the efficiency of the radio frequency signal analysis and/or transfer function-related computations in the control unit, such as by narrowing the computational window to focus on the region most closely related to the current measurement state thereby reducing the computational time.

In yet another example, sudden or fast changes in RF sensing system measurements that could be associated with a large perturbation of the engine system that do not involve changes in the feature being monitored (for example, soot, ammonia, or ash), could be filtered as inaccurate. Near-term history can be used to confirm that a large change in the measured signal cannot occur under certain conditions, such as transient conditions in one example. The change in the RF sensing system measurement could be attributed to a failure of a component, or conditions not accurately captured in the sensor calibration. An example could be a very fast or large change in temperature (either increase or decrease) due to operation of the vehicle near extreme conditions that could result in large temperature gradients across the unit. The calibration functions may not capture these conditions accurately resulting in an erroneous measurement, which may be filtered out or not used. Instead the measurement may be repeated at a different condition to confirm the actual state of the system.

In yet another example, the RF sensing system measurements may be averaged over a predefined time interval, such as a moving average, or historical or time-averaged signal.

Comparison of current RF sensing system measurements with past or historical RF sensing system measurements may also be used to diagnose the state of the engine system or detect changes in the engine system state indicative of malfunctions or failures, such as measurements outside of an acceptable range, historical average, or extrapolated trend based on the historical data, in one example.

In yet another example, the time-scales over which specific engine system parameters are varied may be compared with the time scale of the RF sensing system measurements to separate or compensate for the effects of multiple engine system parameters on the RF measurements. In one particular example with an SCR-coated particulate filter the stored ammonia levels may vary more rapidly than the stored soot or ash levels. The difference in time scales of the RF sensing system measurements, whether over a short time-scale or longer time scale, may be used to determine the relative amount of stored ammonia and soot or ash in one example. In yet another example, the same approach may be applied to determine the amount of stored oxygen on a TWC-coated particulate filter relative to the amount of stored soot or ash. Use of the historical RF measurements over different time scales, may enable multiple engine system parameters to be monitored or detected which may also influence the RF signal at different points in time.

### Intrusive Testing of Engine System

Another means and method in accordance with the present invention for characterizing the operating state and/or performance of the engine system comprises the intrusive testing of the engine system via the application of perturbations to the engine system: (i) high, (ii) low, (iii) sequence with intelligent signature (examples: dithering, pulses, sinusoidal, square wave) and measurement of the system response using RF with or without input from other system sensors or models.

The frequency of the intrusive test may be fixed or varied, and may be done at pre-determined intervals or on-demand. The response to this intrusive test may be used to compute an error signal as the difference between the expected and measured value. Typically, the intrusive test is requested by the RF sensor to other control units that have authority to manipulate the operating conditions of the system being monitored. In some cases, the RF sensor function may be integrated with other functions such as engine operation, or other aftertreatment systems.

Examples of intrusive tests include commanding engine operation to vary or adjust one or more properties or characteristics of the exhaust emitted from the engine. Examples of such properties or characteristics include varying: temperature, flow rate, injection during and timing/timings, or composition, affecting the concentration of gaseous emissions (NOx, CO, CO2, O2, NH3, SO2, and others) as well as the particle content in the exhaust, such as the soot emissions, in another example. The desired variations in the exhaust properties may be achieved by modifying any number of inputs to the engine including: fueling, intake air flow or pressure (boost), EGR rates, intake air temperature, injection timing/timings, and other parameters. Means to achieve the modifications to the inputs include the variation of fuel supply pressure, injection duration, injection timing, intake air throttling, control of the EGR actuator, manipulation of turbocharger waste gate or variable nozzle or vane geometry, changes to the engine speed, and other actuators.

In yet another example, the exhaust system dosing components, such as a hydrocarbon doser or urea injector may be commanded to increase, decrease, or stop dosing in order to perturb the system. Catalyst operation may also be modified to affect downstream components. In one example, urea may be over-dosed on the SCR catalyst in order to detect ammonia storage on the downstream ammonia slip catalyst.

The intrusive test and associated engine system perturbation may be continuous or discrete. Changes to the state of the engine system including the engine 102 or emission control components 108 or 110 or conduit 106 monitored via one or more RF sensors before, after, or during the intrusive test may be compared with a known or expected response. In one example, the expected response may be based on historical data and may change over time or as the engine system ages.

In another example, the expected response may be fixed, such as by comparison of the measured response to a response well known or determined at an earlier time (such as when the engine system was new or just after a full regeneration in the case of diesel particulate filter (DPF)), or comparison with a fixed threshold value or pattern of values. When using a catalyst, resetting the baseline to conditions with known conditions, for example, when ammonia has been fully depleted from the catalyst after ceasing DEF injection. Deviation of the measured response from the expected response may be used to trigger additional intrusive tests, to verify and confirm the response, or to more precisely identify the source of the variation. The same intrusive test may be repeated to confirm the response, or a different intrusive test may be conducted. More than one intrusive test may be conducted simultaneously.

In another example, the agreement of the expected response with the measured response may indicate that the system is functioning correctly. Detection of an abnormal response to the intrusive test may be used to trigger an alarm or fault condition or modify engine or exhaust system operation, such as by initiating a protective action.

The intrusive tests may be used to characterize the engine system operation, or detect or diagnose a fault condition of the engine or of the aftertreatment system. In one example, the RF sensor may be used to monitor engine-out emissions to evaluate or diagnose the engine operation. In another example, the RF sensor may be used to monitor the emission control components to evaluate or diagnose the operation of the emission control system, such as the catalysts, filters, dosers, conduit, and additional sensors present in the engine system. In yet another example, the intrusive test provides a rationality or plausibility check for the RF sensor or for another non-RF sensor or virtual sensor (model).

### Non-Intrusive Testing of Engine System

A further means and method in accordance with the present invention for characterizing the operating state and/or performance of the engine system comprises monitoring of engine system perturbations which may arise during the course of normal operation, i.e. no active stimuli required, to compute an error signal as the difference between the expected and measured value.

The means and method involves recognizing an engine system perturbation or operating condition which occurs during the course of normal operation that can be used to evaluate or characterize the engine system performance. Examples include conducting the RF sensor measurements at a particular temperature or within a particular temperature window in one example. In another example, some other type of criteria or parameter may be used to determine a favorable state to conduct the measurements. The method may also involve a comparison of the RF sensor measurement to an expected value based on the known operating dynamics of the engine system. In this example the error signal may be used for any operating condition.

Engine excursions, such as speed, fueling, or other transient conditions may be used to conduct the measurements. In another example, the measurements need not be conducted over a transient condition or perturbations to the engine system, but rather over a steady-state operating condition. In still another example, the measurement is done at times following engine shut-off or engine startup.

The measurements conducted during portions of normal engine system operation may be compared to the expected results. The comparison or reference condition may take the form of a fixed value, or threshold limit in one example, or may be in the form of an algorithm or model—with or without stored information being used, or a common communication message being broadcast on a communication data bus being used by the control system, or ancillary information available from other sensor inputs in which that information is made available to the RF sensor either directly or indirectly.

In one example the engine system state or emissions rate may be known, mapped, or simulated (modeled or predicted) at particular operating points, such as speed and load conditions. Comparison of the RF measurements with the known or predicted engine system state or emissions rates may be conducted any time during normal operation that the engine traverses these particular operating points. The operating points need not be defined based on engine speed or load but any set of parameters relevant to define a particular reference condition.

### Measurements at Specific Temperature States

A still further means and method of in accordance with the present invention for characterizing the operating state and/or performance of the engine system comprises comparing the RF sensing system signature or resonance curves relative to a baseline or reference curve, data table, or singular value at specific points in time, corresponding to specific temperature conditions, such as with the engine off, during power-on, cool down at power off or open-loop or closed loop engine control conditions. Monitoring the variation in the RF sensing system signal (relative to the baseline or reference condition) at specific temperature conditions is useful to eliminate any temperature-induced variation in the measurements in one example, or to exploit the temperature dependence of the dielectric properties of the material in the engine system to enhance the measurement accuracy in another example

In another example, the measured change in the state of the engine system over a range of temperatures, such as while the engine system is cooling down after power off, provides additional information (rate of change in the RF sensing system signal) to diagnose the health of the engine system. In another example the RF sensing system measurements may be conducted at warm-up, shortly after the engine system is powered on.

### Periodic Wake-Up or Start-Up and Shut-Down Events

Yet a further means and method in accordance with the present invention for characterizing the operating state and/or performance of the engine system comprises the periodic wake-up or activation of the RF sensing system after engine off to conduct measurements to characterize engine system state or change in state.

Examples include measurements of the variation in soot/ash loading or distribution, or NH3, HC, water, or O2 desorption, among others. In another example, the measurements may be used to monitor moisture adsorption on the engine or aftertreatment system, of for the determination of dew point. In yet another example, knowledge of the adsorbed water content on the engine system component may be used to protect the component on warm-up (delay operation of the component) or command or control the energy input to the engine system to reduce the water content or speed the warm-up (light-off) process in yet another example.

Changes in the RF sensing system measurements during a power off condition outside some established threshold limits may indicate a failure or fault condition, if the conditions over which the measurements are conducted are not expected to result in any changes to the engine system. In one example, the monitored changes during periodic wake-up may be used to detect tampering with the engine or aftertreatment system or installation of incorrect components in another example. In yet another example, the periodic measurements with the engine off may be used to monitor gradual changes to the overall dielectric properties of the engine system aftertreatment emission control components, such as a loss of catalytic activity in the case of a catalyst, or a loss of filtration area in the case of a particulate filter (diesel particulate filter, DPF, or gasoline particulate filter GPF) in one example, or the adsorption of water or other species in another example. The RF sensing system measurements may be compared with historical data at the same conditions, or relative to algorithms (models) which may or may not be constant over time, or specific threshold limits or ranges.

Similar to power-off conditions, RF sensing system measurements during engine system shut-down or key-off events, or start-up or key-on events also provide useful information. In particular, these conditions may provide a unique opportunity to isolate or maintain certain parameters constant, while other parameters are varied. In a specific example, during a shut-down event the loading state of the filter or catalyst may not change (for example soot or ash in a particulate filter, or adsorbed gas species on a catalyst) however the temperature of the engine or aftertreatment system may change as the engine cools. These conditions may be preferred for diagnosing the state of the engine or aftertreatment system or detecting anomalies in the RF signal which may be indicative of a system fault or failure. In another example the temperature of the aftertreatment system may be determined based on the variation of the RF signal during shut-down.

RF sensing system measurements during start-up events also provide additional useful information. In one example the water content or stored or condensed water on the particulate filter (DPF, GPF) or catalyst (SCR, TWC, HC trap, or the like) of the engine aftertreatment system may be determined by monitoring the change in the RF signal as the filter or catalyst warms up from ambient temperature (or near ambient) to the engine system operating temperature. In one particular example, the engine system operating temperature may be higher than 100° C., but may be also any suitable operating temperature in another example. The change in the RF sensing system signal between the ambient and operating temperature may be related to water evaporation from the engine system. The measurements may be used for controls applications such as condensation protection for other sensors or components in the engine system (such as thermal shock protection) in one application, or to determine when the condensed or adsorbed water has been fully-removed from the filter or catalyst.

In yet another example, a comparison may be made between measurements of the engine system state (particulate filter or catalyst, in one example) at shut-down and start up. In one embodiment, one or more RF sensing system measurements may be conducted prior to engine system shut-down. During the next start-up event the same RF measurements may be obtained. Comparison of the RF sensing system measurements for the corresponding start-up and shut-down conditions provide information on a change in state of the engine system while the engine system was off. In this manner tampering or malfunctions or failures of the engine system may be detected in one example. In another example the difference between the measurement at shut-down and the measurement at start-up may be due to the addition or loss of material or species to the filter or catalyst, such as water in one example, or ammonia or hydrocarbons in another example.

The RF sensing system measurements conducted at periodic wake-up, shut-down, or start-up conditions may or may not be conducted at specific temperatures. In one embodiment temperature measurements may be used to select and compare the measurements at the periodic wake-up, shut-down or start-up states at the same temperature, or at different temperatures.

### Monitor Changes in the Bulk Dielectric

Yet a further means and method in accordance with the present invention for characterizing the operating state and/or performance of the engine system includes monitoring changes in the bulk dielectric of the engine system emissions control components 108, 118, 110, or 106.

The changes may be abrupt, occurring over a short time period, or gradually occurring over a long time period. The changes may be compared relative to a reference condition, to historical measurements (to ascertain a trend or deviation) or relative to algorithms or models in another example. Applications include monitoring the degradation of catalyst performance (due to thermal aging, sintering, loss of surface area, or poisoning) as well as monitoring the rate of change of poisoning of the catalyst or degradation of the catalyst performance based on changes to its bulk dielectric properties. Similarly, physical defects or flaws in the particulate filter, such as regions with cracks or melted areas, may also be determined in this manner. The measurements may be conducted at pre-defined conditions, or over the course of normal engine operation. Should abnormal characteristics be detected indicative of an engine system fault or failure, the control unit may alert operator of conditions that will damage the unit before actual damage has occurred (provide advance warning).

### Diagnose Temperature Sensors or Improve Temperature Models

In some cases, the dielectric properties of the engine aftertreatment emission control components (catalysts or filters) or the material (solid, liquid, gas) accumulated thereon may be affected by temperature, (i.e. the dielectric properties may exhibit a temperature dependence).

In accordance with this additional means and method in accordance with the present invention for characterizing the operating state and/or performance of the engine system, the temperature profile of various catalysts, filters, or other observable media may have predictable changes in temperature profile that the RF sensor system measurements can be compared to determine if the temperature sensors that are in proximity to the RF sensor measurement are functioning correctly. In another example, the RF measurements may be conducted over a defined window or set of conditions, with some communication from the engine control unit to confirm conditions are acceptable for monitoring temperature changes vs changes in the parameter of interest such as soot, ash, ammonia, or any other suitable species.

### RF-Based Temperature Sensing

In cases where the dielectric properties of the emission control components or emissions collected thereon vary in a known manner with temperature, a still additional means and method in accordance with the present invention for characterizing the operating state and/or performance of the engine system comprises using the RF sensing system/RF sensor measurements to determine the bulk temperature of the emission control device, whether a catalyst, filter, conduit, or some other component.

In one example, the RF sensor may be utilized to measure peak temperatures in the filter, catalyst or observable media, which is useful to prevent damage to the filter, catalyst, or observable media in situations in which a controlled thermal event is utilized to manage the amount of a chemical compound the media is expected to store (examples include soot regeneration of filters or desulfation process for catalysts). In some cases, if the temperature of the engine system is changing along with the level of material collected or retained on the catalyst or filter, additional information from ancillary sensors, the engine controller, or predictive models or lookup tables may be needed to correct the RF sensor response for the variation in the engine system loading or adsorption state in order to obtain accurate temperature measurements. In other words, if two variables are changing and both impact the RF sensing system measurements then one of the variables must be accounted for separately.

In another example, the RF sensing system measurements may be conducted over a regime where the loading state of the emission control device remains constant but where the temperature is varying.

Communication from External Sources

In yet a still further means and method in accordance with the present invention for characterizing the operating state and/or performance of the engine system, communication from external sources can be used to improve the accuracy of the RF sensing system measurements.

For example, information from the engine controller on the amount of urea or HC (hydrocarbons) being dosed into the exhaust system, as well as inputs from other engine system sensors, models, algorithms or look-up tables may be used to further improve the accuracy of the RF-based measurements or RF-based diagnostics of the RF sensing system. This may be particularly important in the case of complex engine systems where multiple variables may affect the RF measurements of any one variable in particular.

In one particular example, knowledge of urea dosing rates or estimated ammonia dosing rates may be used to compensate the RF measurements of the soot and ash levels on an SCR-coated particulate filter. In another example, measurements from an exhaust lambda or oxygen sensor may be used to compensate the RF measurements of the soot and ash levels on a TWC-coated particulate filter.

In another example, materials that may not normally be found in the engine, aftertreatment system, process, or plant may be introduced to evaluate the performance of the engine or aftertreatment system. In one example, an additive (solid, liquid, or gas) may be introduced in the engine or aftertreatment system which exhibits a known dielectric response. The RF response to the introduction of this material may be used to ascertain the health or performance of the catalysts (chemical test) or integrity of a filter (mechanical test). In another example the external material may be collected/monitored downstream from the unit, in case that the unit has failed.

In another example, the detection of an engine system failure condition, such as a failure or malfunction of the engine or of any portion of the engine system emissions control system (catalysts, filters, conduit, or sensors) may be used to trigger an alarm, alert the operator, trigger a fault condition, or initiate an action. Examples include the illumination of an indicator lamp, or the modification of engine operation.

Numerous variations and modifications of the embodiments and methods described above may be effected without departing from the spirit and scope of the novel features of the invention. It is to be understood that no limitations with respect to the radio frequency system and method described herein are intended or should be inferred. It is, of course, intended to cover by the appended claims all such modifications as fall within the scope of the claims.

What is claimed is:

1. A radio frequency emissions sensing system for an engine system comprising:
one or more radio frequency sensors adapted to transmit and receive radio frequency signals to and from one or more emission control components;
a system control unit adapted for collecting and processing radio frequency information from the radio frequency signals transmitted to and received from the one or more radio frequency sensors and controlling one or more system outputs; and
means for the characterization of the operating state and/or performance of the engine system.

2. The radio frequency emissions sensing system of claim 1, wherein the means for the characterization of the operating state and/or performance of the engine system comprises means adapted for the comparison of time-based or historical radio frequency information and/or the one or more sensing system outputs.

3. The radio frequency emissions sensing system of claim 2, further comprising means for storing historical radio frequency information and comparing the historical radio frequency information against the radio frequency information for the characterization of changes in the operating state and/or performance of the engine system.

4. The radio frequency emissions sensing system of claim 1, wherein the means for the characterization of the operating state and/or performance of the engine system comprises means adapted to apply pertubations to the engine system.

5. The radio frequency emissions sensing system of claim 1, wherein the means for the characterization of the operating state and/or performance of the engine system comprises means for monitoring pertubations to the engine system that occur during the operation of the engine system.

6. The radio frequency emissions sensing system of claim 1, wherein the means for the characterization of the operating state and/or performance of the engine system comprises means for comparing the one or more system outputs to a baseline or reference system output or historical output at a predefined condition, where the predefined condition is selected from: temperature, operating mode, start-up or shut-down conditions.

7. The radio frequency emissions sensing system of claim 1, wherein the means for the characterization of the operating state and/or performance of the engine system comprises means for the periodic activation of the radio frequency emissions sensing system after engine system shut-down to conduct measurements to characterize the state or change in state of the engine system.

8. The radio frequency emissions sensing system of claim 1, wherein the means for the characterization of the operating state and/or performance of the engine system comprises means for monitoring changes in the bulk electric of the one or more emissions control components of the engine system.

9. The radio frequency emissions sensing system of claim 1, wherein the means for the characterization of the operating state and/or performance of the engine system comprises means for monitoring the temperature profile of the one or more emissions control components of the engine system.

10. The radio frequency emissions sensing system of claim 1, wherein the means for the characterization of the operation state and/or performance of the engine system comprises means for monitoring the bulk temperature of the one or more emissions control components of the engine system.

11. The radio frequency emissions sensing system of claim 1, wherein the means for the characterization of the operating state and/or performance of the engine system comprises means for communication with external sources to improve the accuracy of the sensing system outputs.

12. A method of operating a radio frequency emissions sensing system for an engine system comprising the steps of:
providing one or more radio frequency sensors for transmitting and receiving radio frequency signals to and from one or more emission sensing components;
providing a system sensing unit for collecting and processing radio frequency information from the radio frequency signals transmitted to and received from the one or more radio frequency sensors and controlling one or more system outputs; and
characterizing the operating state and/or performance of the engine system.

13. The method of claim 12, wherein the step of characterizing the operating state and/or performance of the engine system comprises the step of comparing time-based or historical radio frequency information and/or the one or more sensing system outputs.

14. The method of claim 13, further comprising the step of storing historical radio frequency information and comparing the historical radio frequency information against the radio frequency information for the characterization of changes in the operating state and/or performance of the engine system.

15. The method of claim 12, wherein the step of characterizing the operating state and/or performance of the engine system includes the step of applying pertubations to the engine system.

16. The method of claim 12, wherein the step of characterizing the operating state and/or performance of the engine system comprises the step of monitoring pertubations to the engine system that occur during the operation of the engine system.

17. The method of claim 12, wherein the step of characterizing the operating state and/or performance of the engine system comprises the step of comparing the one or more system outputs to a baseline or reference system output or historical output at a predefined condition, where the predefined condition is selected from: temperature, operating mode, start-up or shut-down conditions.

18. The method of claim 12, wherein the step of characterizing the operating state and/or performance of the engine system comprises the step of periodically activating the radio frequency emissions sensing system after engine system shut-down to conduct measurements to characterize the state or change in state of the engine system.

19. The method of claim 12, wherein the step of characterizing the operating state and/or performance of the engine system comprises the step of monitoring changes in the bulk electric of the one or more emissions sensing components.

20. The method of claim 12, wherein the step of characterizing the operating state and/or performance of the engine system comprises the step of monitoring the temperature profile of the one or more emissions control components.

21. The method of claim 12, wherein the step of characterizing the operating state and/or performance of the engine system comprises the step of monitoring the bulk temperature of the one or more emissions control components.

22. The method of claim 12, wherein the step of characterizing the operating state and/or performance of the engine system comprises the step of communicating with external sources to improve the accuracy of the sensing system outputs.
